(19) United States
(12) Patent Application Publication
(10) Pub. No.: US 2024/0057620 A1
(43) Pub. Date: Feb. 22, 2024

(54) AN ITEM OF FOOD, GRILLING APPARATUS, AND METHOD OF MAKING AN ITEM OF FOOD

(71) Applicant: Yuen Ling Bonnie Wong, Kowloon Tong, Kowloon (HK)

(72) Inventor: Yuen Ling Bonnie Wong, Kowloon Tong, Kowloon (HK)

(21) Appl. No.: 18/259,515

(22) PCT Filed: Dec. 28, 2021
(86) PCT No.: PCT/CN2021/142030

§ 371 Date: Jun. 27, 2023

(30) Foreign Application Priority Data
Dec. 28, 2020 (HK) 32020022796.7

(51) Int. Cl. A21D 13/14; A21D 13/33; A21D 13/42; A47J 37/06

(52) U.S. Cl. CPC A21D 13/14; A21D 13/33; A21D 13/42; A47J 37/0629; A47J 37/0664

(57) ABSTRACT

Grilling apparatus (100) has a receptacle (104) for receiving a food material sheet having an upper end (108) through which the food material sheet is placed into the receptacle, a smaller lower end (110), and a wall (112) having an inner surface (114) for contacting/supporting the food material sheet. A heating element (106) behind the inner surface heats the food material sheet to a shape corresponding to the inner surface. A vent (116, 118, 132) through the inner surface allows air to enter during heating of the food material sheet. Also, an item of food has a body with a wall formed by rolling up an assembly of a first layer of food material, a second layer of food material, and filling food material therebetween. The rolled-up assembly is heated to retain shape, preferably using the grilling apparatus.

### FIELD OF THE INVENTION

The invention relates to grilling apparatuses, and particularly, although not exclusively, to grilling apparatuses for preparing food using a food material sheet. The invention also relates to items of food, and methods of making thereof.

### BACKGROUND OF THE INVENTION

Grilling apparatuses are usually used for cooking raw food, e.g. a steak, or warming cooked food, e.g. a panini. For example, they can be used in preparing for a warm tortilla wrap. Typically, a tortilla is first placed flat on the griller to be heated. The filling is then placed on the flat heated tortilla, and the tortilla is folded and rolled up to enclose the filling and served as a tortilla wrap.

### SUMMARY OF THE INVENTION

According to a first aspect of the invention, there is provided an item of food, comprising: a body for retaining food elements, the body having a wall defining a larger open end through which the food elements may be placed in the body and a smaller closed end. The wall is formed by: rolling up an assembly of a first layer of food material, a second layer of food material, and a filling food material arranged therebetween, such that the rolled-up assembly assumes a shape; and heating the rolled-up assembly to retain the shape of the rolled-up assembly.

The body may consist of the wall. The body may have a generally conical shape. Alternatively, the body may have a generally frusto-conical shape.

The smaller closed end may be formed by folding a portion of a periphery of the assembly inwards.

Upper peripheries of each of the first layer of food material and the second layer of food material may be substantially aligned with each other.

At least one of the first layer of food material and the second layer of food material may be generally circular. Alternatively, one of the first layer of food material and the second layer of food material is generally circular, and the other one is fan-shaped.

The first layer of food material and the second layer of food material may have substantially the same shape and size.

The first layer of food material and the second layer of food material may be cooked food materials. The first layer of food material and the second layer of food material may be cooked doughs, e.g. food material sheets.

The rolled-up assembly may be relatively soft and the wall may be relatively hard.

The filling food material may occupy substantially the entire space between the first layer of food material and the second layer of food material.

The filling food material may be different from the first layer of food material and the second layer of food material. The filling food material may be a meltable food material.

According to a second aspect of the invention, there is provided a grilling apparatus for preparing food using a food material sheet, including a receptacle for receiving a said food material sheet, the receptacle having an upper end through which a said food material sheet may be placed into the receptacle, a lower end smaller than the upper end, and a wall having an inner surface extending across the upper end and the lower end and arranged to contact and support a said food material sheet placed inside the receptacle. The grilling apparatus also includes a heating element provided adjacent and behind the inner surface for applying heat through the inner surface to a said food material sheet placed inside the receptacle, thereby grilling a said food material sheet to a shape corresponding to that of the inner surface. The receptacle includes a vent through the inner surface to allow air to enter into the receptacle from outside during grilling of a said food material sheet.

The vent may be provided adjacent the lower end of the receptacle. The vent may comprise an aperture through the wall of the receptacle.

Alternatively, the vent may extend on and along at least part of the inner surface of the receptacle. The vent may comprise at least one channel extending to between the upper end and the lower end of the receptacle. The plurality of said channels may be regularly spaced apart from each other.

The inner surface may extend linearly across the upper end and the lower end of the receptacle. The receptacle may have a generally inverted conical shape, e.g. an inverted frusto-conical shape.

The heating element may extend around the receptacle. Optionally, the heating element is of a spiral shape.

The grilling apparatus may further include a presser adapted to be insertable into the receptacle for exerting a force to bear a said food material sheet against the inner surface of the receptacle, thereby maintaining contact therebetween. The presser may have a body of a shape and size complementary to those of the receptacle.

The body may have a generally inverted conical shape, e.g. an inverted frusto-conical shape.

Optionally, the presser includes a handle connected to the body, extending along a longitudinal axis of the latter. The body may be made of a metal, and the handle may be made of a non-metal.

The body may be a hollow structure with an open outer surface that has an air-permeable surface.

The body may comprise a plurality of protrusions extending from a central axis of the body. The plurality of protrusions may be in form of fins. Each fin may be solid, or each fin may be hollow and formed by a wire. Optionally, the body is in the form of a cage.

Preferably, the body includes a plurality of edges on and around its outer periphery, which extend generally across opposite ends of the body.

More preferably, the edges extend linearly across opposite ends of the body.

The grilling apparatus may further include a housing in which the receptacle is provided. Optionally, the grilling apparatus includes a plurality of said receptacle and respective heating elements, with upper ends thereof arranged on an upper surface of the housing.

According to a third aspect of the invention, there is provided a method of making an item of food according the first aspect, comprising the steps of: rolling up the assembly of the first layer of food material, the second layer of food material, and the filling food material arranged therebetween; and placing the rolled-up assembly into the receptacle of a grilling apparatus, whereby the rolled-up assembly is heated to form the item of food. The grilling apparatus in this aspect may be the grilling apparatus according to the second aspect.

The step of rolling up the assembly may comprise the steps of: placing the filling food material between the first layer of food material and the second layer of food material to form the assembly; and then, irrespective of order, folding a lateral side of the assembly inwards; folding a portion of a periphery of the assembly between opposite lateral sides inwards; and folding the opposite lateral side inwards, thereby forming the assembly with the smaller closed end.

The method may further include the step of inserting a presser of the grilling apparatus into the receptacle to exert a force to bear the rolled-up assembly against the inner surface of the receptacle, thereby maintaining contact therebetween for grilling.

The method may further include the step of pre-heating the presser before inserting the presser into the receptacle.

The step of pre-heating the presser may include inserting the presser into the receptacle for pre-heating.

After the step of inserting the presser into the receptacle and prior to the step of placing the rolled-up assembly into the receptacle, the method may further include the step of removing the pre-heated presser from the receptacle. After the step of placing the rolled-up assembly into the receptacle, the method may further include the step of re-inserting the pre-heated presser into the receptacle to exert a force to bear the rolled-up assembly against the inner surface of the receptacle, thereby maintaining contact of the first and second layers of food material with the inner surface of the receptacle and an outer surface of the presser respectively for grilling.

### BRIEF DESCRIPTION OF THE DRAWINGS

Embodiments of the invention will now be described, by way of example only, with reference to the accompanying drawings, in which:

FIG. 1 is a front view of a grilling apparatus in accordance with one embodiment of the invention;

FIG. 2 is a top view of the grilling apparatus of FIG. 1;

FIG. 3 is a cross-sectional view of the grilling apparatus of FIG. 1, taken along line 3-3 in FIG. 1 with portions removed;

FIG. 4 is a top view of a receptacle of a grilling apparatus in accordance with one embodiment of the invention;

FIG. 5 is a cross-sectional view of the receptacle of FIG. 3, taken along line 5-5 in FIG. 4;

FIG. 6 is a side view of a presser of a grilling apparatus in accordance with one embodiment of the invention;

FIG. 7 is a perspective view of a presser of a grilling apparatus in accordance with one embodiment of the invention;

FIG. 8 is a side view of the presser of FIG. 7;

FIG. 9 is a bottom end view of the presser of FIG. 7;

FIG. 10 is a perspective view of a presser of a grilling apparatus in accordance with one embodiment of the invention;

FIG. 11 is a side view of the presser of FIG. 10;

FIG. 12A is a bottom end view of the presser of FIG. 10;

FIG. 12B is a top end view of the presser of FIG. 10;

FIG. 13 is a perspective view of a presser of a grilling apparatus in accordance with one embodiment of the invention;

FIG. 14 is a cross-sectional view of the grilling apparatus of FIG. 1 with a presser and a multi-layered tortilla placed therein in accordance with one embodiment of the invention;

FIG. 15 is a flow chart showing a method of forming a single-layered rolled-up tortilla in accordance with one embodiment of the invention;

FIG. 16 is a flow chart showing a method of forming a multi-layered rolled-up tortilla in accordance with one embodiment of the invention;

FIG. 17 is a flow chart showing a method of forming a multi-layered rolled-up tortilla in accordance with one embodiment of the invention; and

FIG. 18 is an image showing a multi-layered rolled-up tortilla in accordance with one embodiment of the invention.

### DETAILED DESCRIPTION OF PREFERRED EMBODIMENTS

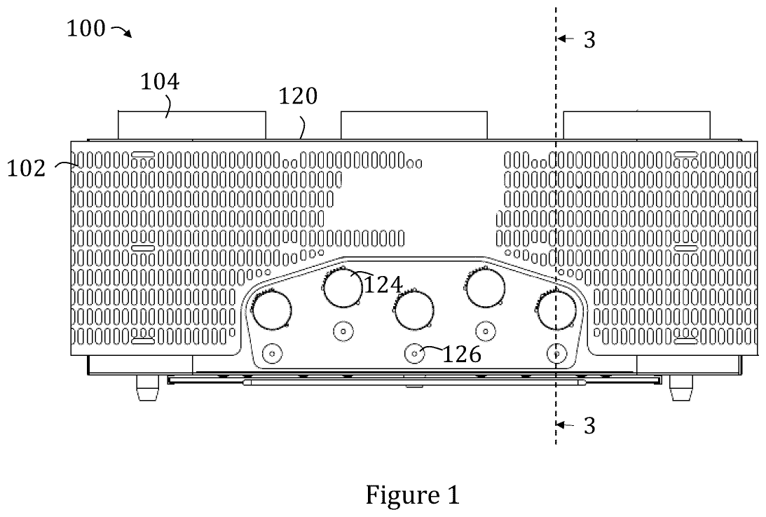

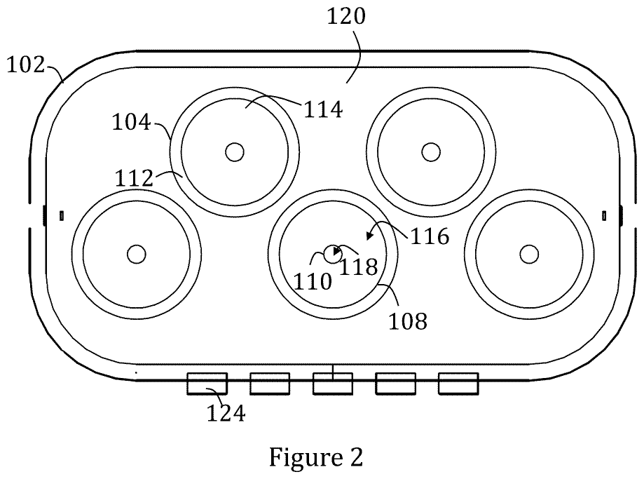

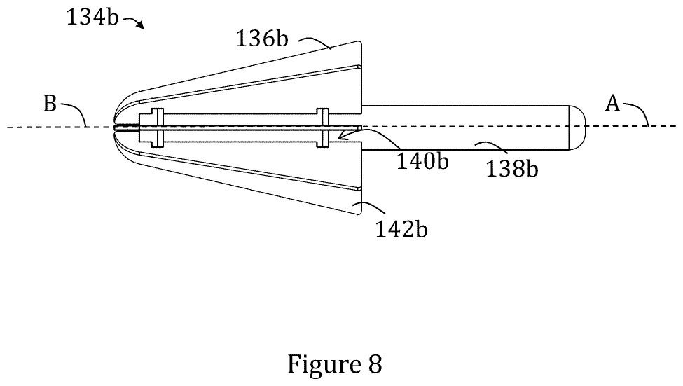

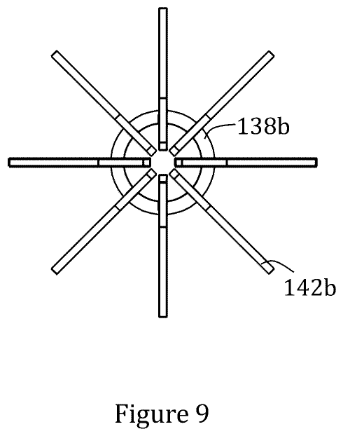

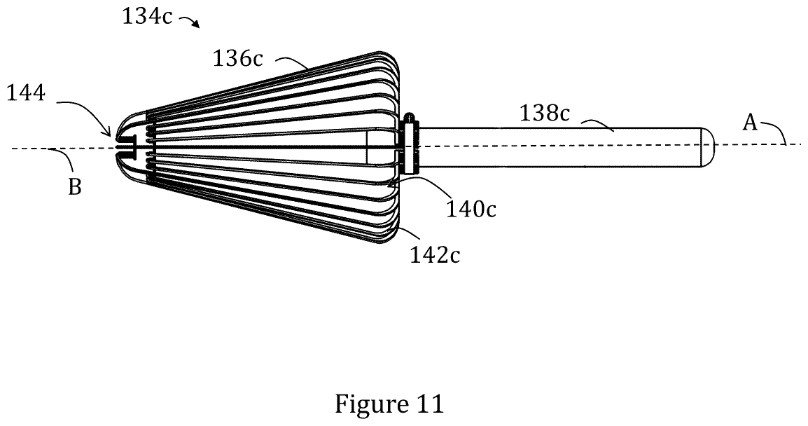

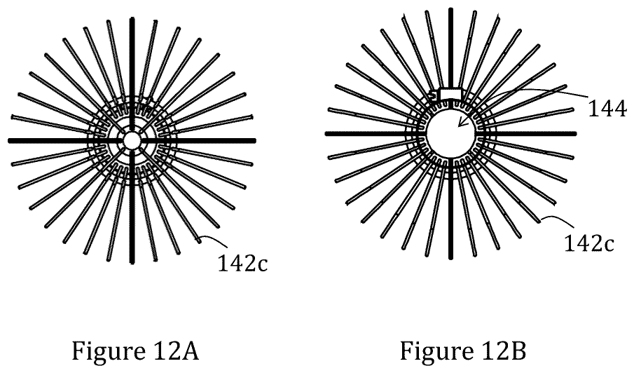

FIGS. 1 to 14 show a grilling apparatus 100 for preparing food using a single food material sheet or multiple food material sheets in accordance with one embodiment of the invention. The grilling apparatus 100 is capable of not only heating and cooking the food material sheet, but also supporting and maintaining a shape of (i.e. shaping) the food material sheet. The food material sheet may be a flat cooked dough such as a tortilla for making a tortilla wrap. In order to prepare a tortilla wrap with a filling such as salad leaves or meat, it is desired for the grilled tortilla to have a shape and structure that can hold such filling and prevent it from falling out from the tortilla, i.e., the filling is wrapped by the tortilla that is in the form of a receptacle with a closed end or bottom. Preferably, the tortilla is rolled up before being grilled by the grilling apparatus.

In one example embodiment, the grilling apparatus 100 is used for preparing an inverted frusto-conical-shaped tortilla wrap using a soft tortilla, with the bottom end thereof closed, such that the tortilla wrap can be served directly after the filling is placed inside the cone, without requiring further rolling of the tortilla to hold the filling.

The grilling apparatus 100 includes a housing 102, a plurality of receptacles 104 received in and fixed to the housing 102, and respective heating elements 106 provided adjacent the respective receptacles 104. Each receptacle 104 has an upper annular open end 108, a lower annular open end 110, and a wall 112 with a smooth inner surface 114 extending linearly across the upper and lower ends 108, 110, where the lower end 110 is smaller than the upper end 108. In other words, the receptacle 104 has an inverted frusto-conical shape with an opening or vent 116 at the upper end 108 and another opening or vent 118 at the lower end 110.

The upper end 108 of the receptacle 104 is arranged on an upper open surface 120 of the housing 102, such that the upper end 108 of the receptacle 104 is open to the surroundings, allowing the tortilla to be received and placed into the receptacle 104. The inner surface 114 of the wall 112 is arranged to contact and support the tortilla placed inside the receptacle 104. Both the vents 116, 118 at the upper and lower ends 108, 110 are provided as, generally stated, apertures through the inner surface 114 of the wall 112 to allow air to enter into the receptacle 104 from outside during grilling of the tortilla. In this embodiment, the receptacle 104 includes only two openings, the vents 116 and 118. In addition, the vent 118 at the lower end 110 allows for an efficient convection that carries moisture from the tortilla during heating/grilling away from the receptacle 104, thereby preventing the moisture to be trapped within the receptacle 104 or the tortilla itself, which would otherwise result in an undesired soggy tortilla. Preferably, the lower end 110 should be small enough to hold the tortilla within the receptacle 104. The inverted frusto-conical shape, specifically the larger upper end 108 and the smaller lower end 110, allows the tortilla to be easily inserted into and well-supported by the receptacle 104.

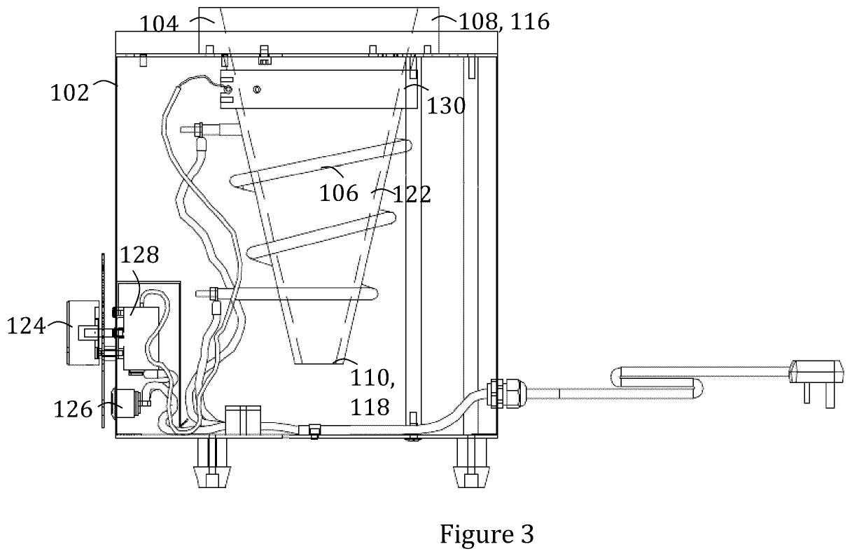

With reference to FIG. 3, each heating element 106 is provided behind the inner surface 114 of the receptacle 104. Specifically, the heating element 106 extends spirally around an outer surface 122 of the receptacle 104, with an increasing diameter for each turn towards the upper end 108 of the receptacle 104. Such an arrangement allows heat to be evenly applied through the inner surface 114 to the tortilla, thereby grilling, and potentially hardening and crisping, the soft tortilla to an inverted frusto-conical shape corresponding to that of the inner surface 114. The illustrated heating elements 106 can be operated individually using separate controllers 128.

In the illustrated embodiment, the housing 102 also accommodates different electrical components for controlling operation of the grilling apparatus 100, including actuators 124, indicators 126, and controllers 128 each operably connected between one actuator 124 and one indicator 126. As shown in FIG. 3, the grilling apparatus 100 is connected to an AC power source which supplies electrical power to the heating elements 106 via the electrical components. Each actuator 124 is configured in the form of a dial to be actuated by a user to control the operation of the heating element 106, for example, to turn the heating element 106 on and off. Each indicator 126 is configured to indicate the on/off state of the heating element 106 in response to the actuation of the actuator 124 by the user. In the illustrated embodiment, the indicators 126 include a lighting element that is, for example, configured to turn on when the heating element 106 is on and to turn off when the heating element 106 is off.

The electrical components also include respective temperature sensors 130 such as resistance temperature detectors (RTDs) coupled or attached to the upper ends 108 of the respective receptacles 104 for detecting a temperature of the receptacles 104. The temperature sensors 130 are also operably connected to the controllers 128. For example, the temperature sensor 130 may detect that the receptacle 104 reaches a desired temperature, or is overheating, and then sends a signal to the controller 128, which in turn controls the heating element 106 to turn off.

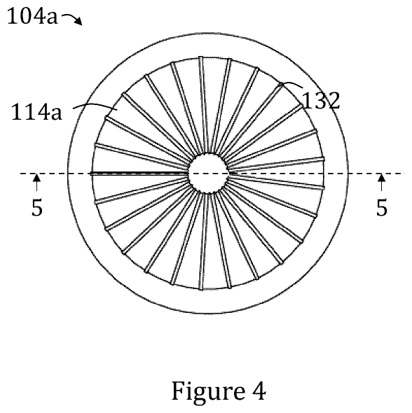

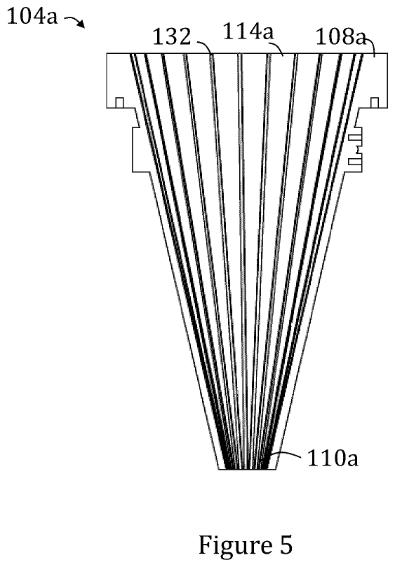

FIGS. 4 and 5 show a receptacle 104a in accordance with an alternative embodiment. The receptacle 104a may also be received in the housing 102. The following description focuses primarily on the structure and features of the receptacle 104a that are different from those of the receptacle 104 described above, with equivalent parts designated by the same reference numerals suffixed by a letter “a”.

The inner surface 114a of the receptacle 104a includes a plurality of vents configured as channels 132 defined by a plurality of grooves and extending linearly on and along the inner surface 114a to between the upper and lower ends 108a, 110a of the receptacle 104a, and in particular spanning the entire slanted height of the receptacle 104a. The channels 132 are regularly spaced apart from each other, providing pathways for moisture to escape in addition to the aperture at the lower end 110a. During grilling of the tortilla, moisture or water vapor given out from the tortilla and in particular from the underside thereof is facilitated to rise under convection through and along the channels 132, with air being drawn in from below through the lower end 110a, and then exit from the upper end 108a.

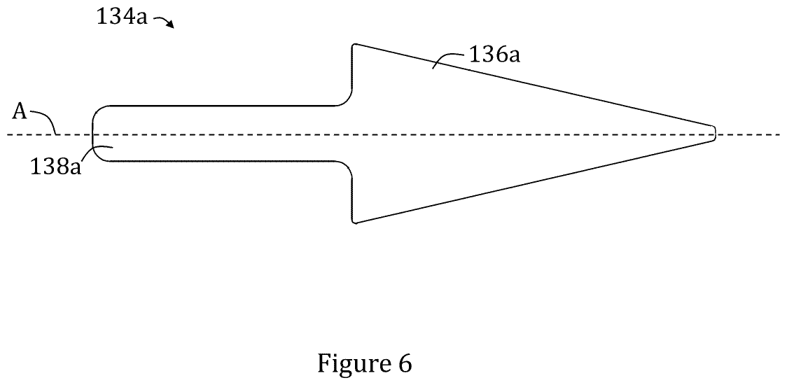

The rolled-up tortilla may alter its shape or structure when being grilled, for example, it may shrink. Therefore, to better maintain the shape and structure of the tortilla and in particular keeping it against the inner surface 114, 114a of the receptacle 104/104a, the grilling apparatus 100 is further provided with a presser, for example, any one of the pressers 134a-e in FIGS. 6 to 14. In general, preferably, the presser has a body with a shape and size complementary to those of the receptacle 104/104a, i.e., an inverted frusto-conical shape with a similar size. The presser is adapted to be insertable into the receptacle 104/104a during grilling for exerting a force to bear the tortilla against the inner surface 114, 114a of the receptacle 104/104a, thereby maintaining contact therebetween and maintaining the inverted frusto-conical shape of the rolled-up tortilla.

FIG. 6 shows a presser 134a in accordance with one embodiment of the invention. The presser 134a includes an inverted frusto-conical and solid body 136a and a handle 138a integrally formed with the body 136a and extending along a longitudinal axis A of the body 136a. The handle 138a and the body 136a may be made of a thermal insulating material such as wood, so as to protect the user when using or removing the presser 134a from the receptacle 104/104a. The solid body 136a helps achieving better contact of the tortilla with the inner surface 114, 114a of the receptacle 104/104a, thus allowing heat to be evenly distributed to the tortilla.

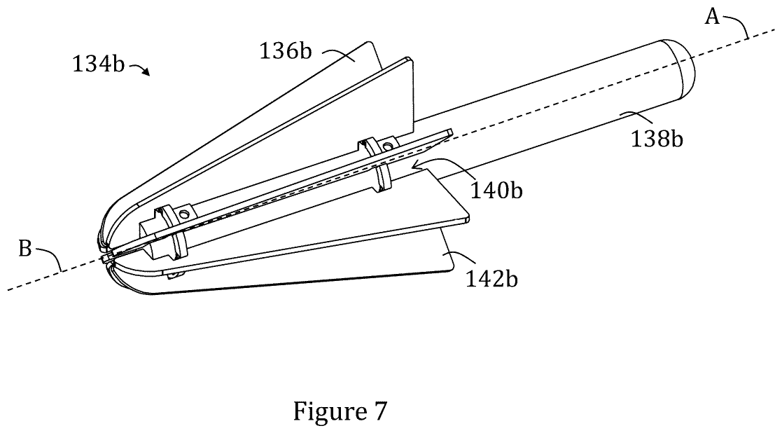

FIGS. 7 to 9 illustrate a presser 134b in accordance with an alternative embodiment of the invention. The presser 134b includes a handle 138b and an inverted frusto-conical body 136b having a hollow structure with an open surface 140b and connected to the handle 138b. The open surface 140b is configured as an air-permeable surface including spaces that extend between and through the outermost side of the body 136b to the innermost side of the body 136b, i.e., the portion connecting the handle 138b. The handle 138b may be made of a thermal insulating material or non-metal (e.g. wood, plastic, nylon, etc.), while the body 136b may be made of a thermal conductive and durable material such as metal (e.g. stainless steel), so as to extend the lifetime of the presser 134b. The body 136b includes a plurality of protrusions in the form of solid fins 142b with both ends extending from the handle 138b and from a central axis B of the body 136b, where the central axis B is arranged centrally along the length of the body 136b and coaxially with the handle's longitudinal axis A. The fins 142b have a slanted height that is substantially the same as the slanted height, taken radially, of the inverted frusto-conical shape of the receptacle 104/104a. The fins 142b further facilitate moisture removal by providing additional pathways between adjacent fins 142b for water vapor to escape from the inner side of the tortilla.

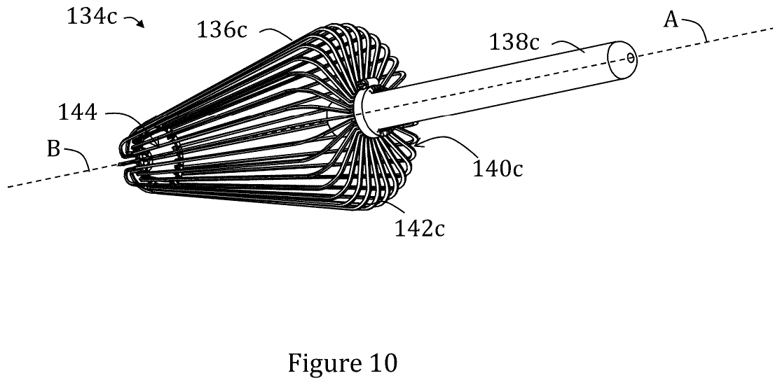

FIGS. 10 to 12B illustrate a presser 134c in accordance with yet another alternative embodiment of the invention. The presser 134c is similar to the presser 134b in that the presser 134c is also provided with fins 142c and a hollow structure with an open surface 140c that facilitates moisture removal. Similarly, the handle 138c may be made of a non-metal and the body 136c may be made of a metal. In this embodiment, the fins 142c are each formed by a thin wire. The fins 142c are, at one end, connected to and extending outwardly from an end of the handle 138c about the central axis B, and at the other end, extending inwardly towards the central axis B and connected to the respective ends of the adjacent wires, thus forming a bird cage-like structure. The bird cage-like structure has an open lower end 144 that further facilitates steam to escape. In addition, the relatively dense arrangement of the wires provides an increased contact area for the tortilla against the inner surface 114, 114a of the receptacle 104/104a and hence an increased pressure on the tortilla, achieving better grilling.

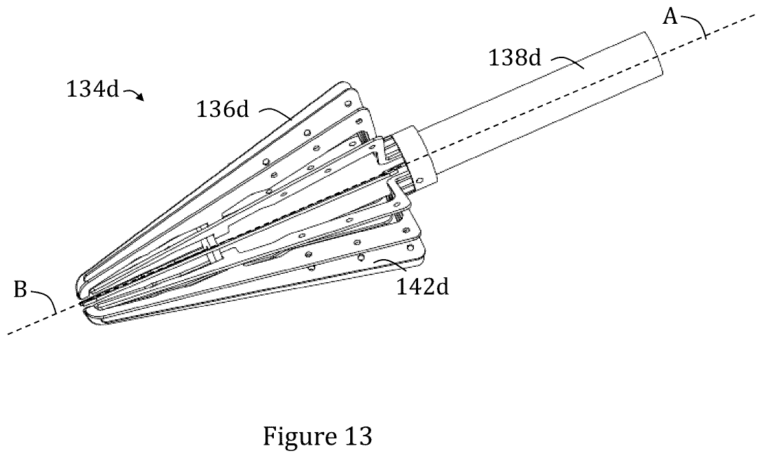

FIG. 13 shows a presser 134d in accordance with yet another alternative embodiment of the invention. The presser 134d is similar to the presser 134c in that the body 136d of the presser 134d also includes a bird cage-like structure. However, instead of a bird cage-like structure formed with thin wires, the bird cage-like structure of the presser 134d is formed with generally E-shaped fins 142d. Similar to the presser 134b, the three teeth of the E-shaped fins 142d extend from a handle 138d and from a central axis B of the body 136d, where the central axis B is arranged centrally along the length of the body 136b and coaxially with the handle's longitudinal axis A. As such, a gap is formed between the recessed portions between the teeth on each fin 142d and the handle 138d, thus allowing moisture to flow therethrough. The fins 142d have a slanted height that is substantially the same as the slanted height, taken radially, of the inverted frusto-conical shape of the receptacle 104/104a.

Each of the pressers 134b, 134c, 134d includes, on and around its conical outer periphery, a plurality of edges that extend generally across opposite ends of the body 136b, 136c, 136d. Such edges are peripheral edges provided by the outermost slanted edges of the fins 142b in the presser 134b, or by the wires (that form the fins 142c) in the presser 134c, or by the generally E-shaped fins 142d in the presser 134d. These edges extend linearly across the opposite ends of the body 136b, 136c, 136d. While being provided or presented on the outer periphery, the edges are where the presser 134b, 134c, 134d will contact and press upon the tortilla and they will apply a concentrated force by reason of them being protrusions to the tortilla, thereby forming respective fold lines on the inner surface of the grilled tortilla.

The presence of such fold lines renders the tortilla wrap (containing food) readily collapsible about and along the fold lines while maintaining integrity of the wrap, i.e. without breaking or cracking, such that the wrap can be squeezed by a person into a flatter or thinner form to make it easier to be put into the mouth.

The grilling apparatus 100 may also be used for preparing a multi-layered tortilla. In cases where the multi-layered tortilla is thick, e.g. containing ham and egg as food filling materials between two tortilla sheets, the above pressers 134a-d, having a similar shape and size to the receptacle 104/104a, may hardly be inserted into the receptacle 104/104a.

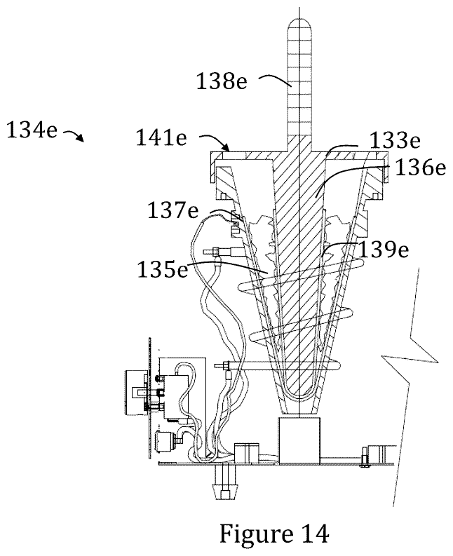

FIG. 14 illustrates a presser 134e being inserted into the receptacle 104 (or receptacle 104a) as yet another alternative embodiment of the invention that is designed for use with a thick multi-layered tortilla. Different from the pressers 134a-d, instead of having shape and size complementary to those of the receptacle 104, the presser 134e has an elongated body 136e, a handle 138e, and a generally circular flange 133e extending outwardly from between the handle 138e and the body 136e. In the illustrated embodiment, the body 136e and the flange 133e are integrally formed. The elongated body 136e, when being inserted into the receptacle 104/104a, is spaced apart from the inner surface of the receptacle 104/104a, such that a sufficient space is provided for the thick multi-layered tortilla. The flange 133e has a few openings 141e around the periphery thereof, such that when the presser 134e is placed within the receptacle 104/104a, the flange 133e substantially covers the upper end 108, 108a of the receptacle 104/104a, while leaving openings for escape of moisture during grilling.

When a multi-layered tortilla having a filling food material 135e between two tortillas 137e, 139e is placed within the receptacle 104/104a for grilling, and when the presser 134e is inserted therein, the surface of the elongated body 136e contacts and exerts a force on the inner tortilla 139e. By providing sufficient space between the presser 134e and the inner surface of the receptacle 104/104a for the tortilla, the elongated body 136e, compared to that of the pressers 134a-d, avoids over-pressing the multi-layered tortilla and thus over-flowing of the filling food material 135e from between the two tortillas 137e, 139e.

In a preferred embodiment, the presser 134a-e is pre-heated before it is used during grilling of the tortilla, so that it may then be used to apply heat directly to (i.e. grill) the inner side of the tortilla, while the receptacle 104/104a being heated by the heating element 106 is used to grill the outer side of the tortilla.

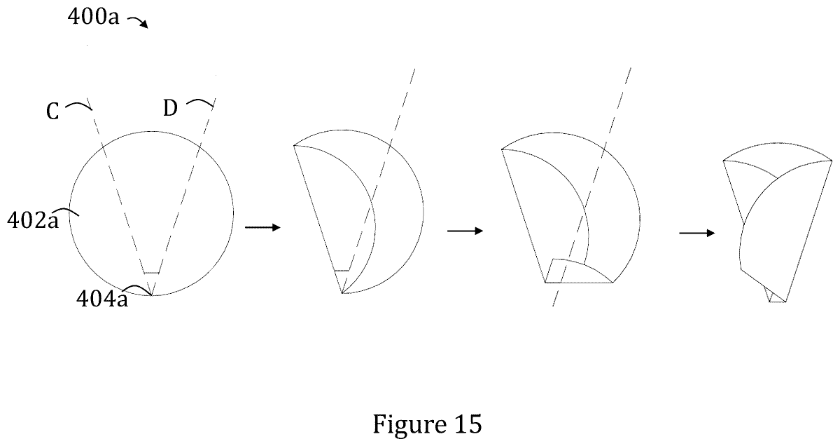

FIG. 15 shows an example method 400a of folding or rolling up a circular tortilla 402a to form a single-layered rolled-up tortilla. First, one lateral side (e.g. a left section) of the tortilla 402a is folded inwards towards a center or main body of the tortilla 402a along an axis C that includes a chord intersecting a bottom end 404a of the tortilla 402a. Then, the bottom end 404a, including a small portion of the periphery between the opposite lateral sides, is folded inwards and towards the center of the tortilla 402a to form the smaller closed end. Next, the opposite lateral side (e.g. a right section) of the tortilla 402a is folded inwards along an axis D that includes another chord which also intersects the same bottom end 404a as the axis C, such that the resultant tortilla, when expanded 3-dimensionally, has an inverted frusto-conical shape with the bottom closed, corresponding to the inverted frusto-conical shape of the receptacle 104/104a. The illustrated sequence of folding allows the resultant tortilla to be expanded widely enough to contain fillings.

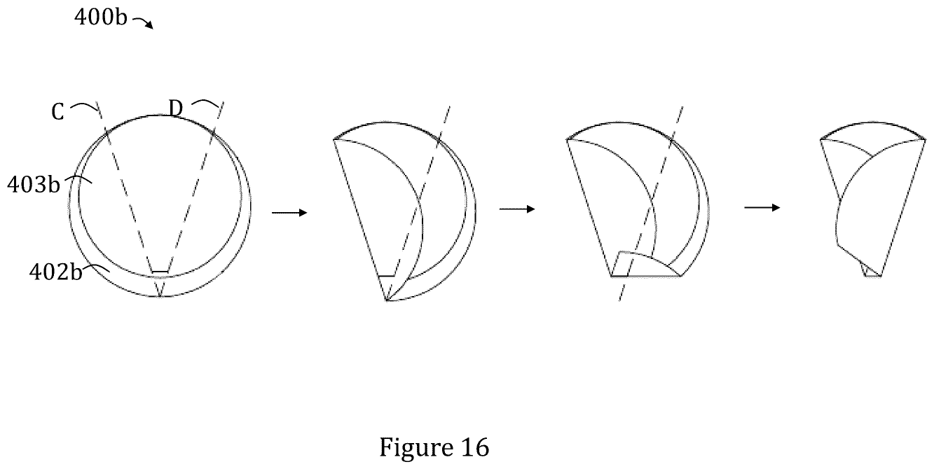

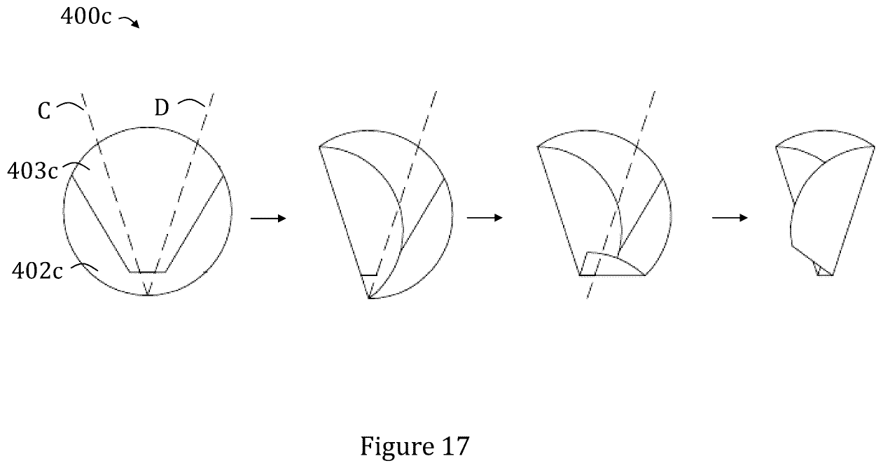

FIGS. 16 and 17 show example methods 400b, 400c of preparing and forming a multi-layered rolled-up tortilla with a smaller closed end by rolling up, e.g. over 360°, an assembly of two layers of food material and a filling food material sandwiched therebetween. The first and second layers may be of the same type of food material, such as the same type of tortilla. The filling food material may be the same as or, preferably, different from the food material of the first and second layers, and may be meltable or non-meltable food material, such as cheese in particular, or ham or egg, etc.

In the example illustrated in FIG. 16, the assembly is first prepared by stacking, in sequential order, a first layer of food material e.g. tortilla 402b, a filling food material e.g. cheese (not shown), and a second layer of food material e.g. tortilla 403b, which has a similar shape (e.g. generally circular) but a slightly smaller size compared to the first layer. The second tortilla 403b is stacked on top of the filling food material and the first tortilla 402b such that the upper peripheries of both tortillas 402b, 403b are generally aligned. Such alignment allows the resultant rolled-up assembly to have a generally even thickness with the filling food material evenly distributed between the two tortillas 402b, 403b. The remaining process of folding or rolling up is similar to that of the method 400a illustrated in FIG. 15, where both lateral sides and a bottom end of the overlapping tortillas are folded inwards; thus will not be repeated herein. In the rolled up condition, the first tortilla 402b is the outer layer and the second tortilla 403b becomes the inner layer.

The example illustrated in FIG. 17 is similar to that in FIG. 16, except the second layer 403c is made fan-shaped instead of a generally circular shape. The fan-shaped tortilla 403c is cut from a circular tortilla, such that the second layer 403c is slightly smaller than the first layer 402c. As shown in FIG. 17, the fan shape is generally an inverted isoceles trapezium with its longer base being an arc. To form the assembly, a stencil of the size and shape of the fan-shaped tortilla 403c is first placed on top of the first tortilla 402c. Then, a filling food material is placed on, and only on, the exposed area of the first tortilla 402c. After removing the stencil, the fan-shaped tortilla 403c is placed on top of the filling food material, thus forming an assembly with the filling food material sandwiched between the two tortillas 402c, 403c. The second tortilla 403c is positioned such that the upper peripheries of the two tortillas 402c, 403c, i.e. the arc of the fan-shaped second tortilla 403c and the upper perimeter of the first tortilla 402c are generally aligned with each other, leaving a generally U-shaped lower peripheral portion of the first tortilla 402c exposed. The exposed peripheral portion, after being rolled up, helps to reduce overlapping of tortilla layers in the wall of the rolled-up assembly, thus minimizing its thickness and achieving better mouthfeel. The remaining process of folding or rolling up is similar to that of the method 400a illustrated in FIG. 15, where both lateral sides and a bottom end of the tortillas are folded inwards; thus will not be repeated herein.

In a preferred embodiment, the step of rolling up the assembly may be performed on a surface, e.g. a kitchen board, marked up with indications of the shape and size of the food material tortillas, the fold lines, etc. to facilitate preparation of the rolled-up assembly neatly and with even thickness.

In the illustrated embodiments, the axes C, D divide the circular shape of the single-layered or multi-layered tortilla into three i.e. left, middle and right sections having roughly the same size, such that the left and right sections can be folded upon one another and sufficiently overlap to form a receptacle. The resultant folded or rolled-up tortilla is then expanded and inserted into the receptacle 104/104a, via the latter's upper end 108, 108a, of the grilling apparatus 100 for grilling.

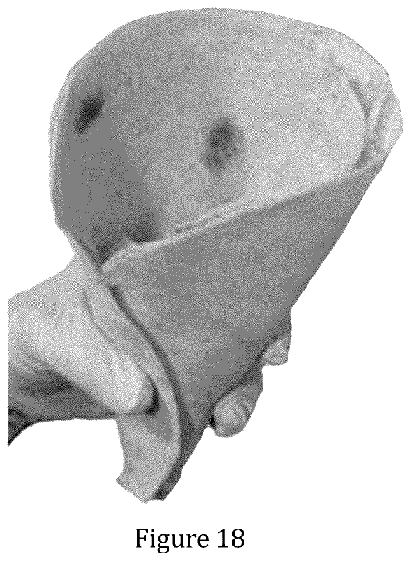

FIG. 18 shows an example of a multi-layered rolled-up tortilla having a generally conical shape that is, e.g., formed using the method 400b or 400c. The tortilla may be grilled using the grilling apparatus 100 to harden thereby retaining its shape and to become crispy. Similar to the single-layered rolled-up tortilla, the multi-layered rolled-up tortilla has a body for containing food pieces. The body consists of a wall defining a larger open end through which the food pieces may be placed in the body and a smaller closed end to hold the food pieces. The upper peripheries of the two layers are generally aligned with each other.

In one example, the rolled-up tortilla assembly assuming the generally conical or frusto-conical shape in FIG. 18 may be placed into the receptacle 104/104a of the grilling apparatus 100 for grilling to fix the shape and achieve crispiness. A presser (e.g. any one of the pressers 134a-e) may be used and inserted into the receptacle 104/104a to exert a force to bear the tortilla assembly against the inner surface of the receptacle 104/104a, thereby maintaining contact therebetween for grilling. As discussed above, the presser may be pre-heated before use and is conveniently pre-heated in the same receptacle (absent the tortilla assembly) or another vacant receptacle of the grilling apparatus 100. The pre-heated presser is removed from the receptacle, before the tortilla assembly is put into the receptacle, and subsequently re-inserted into the receptacle to press the tortilla assembly against the wall of the receptacle, thereby maintaining contact of the outer tortilla with the inner surface of the receptacle and the inner tortilla with an outer surface of the presser for grilling.

When the filling food material is a meltable food material such as cheese, the molten food material or cheese will spread across the space between the two tortillas in the resultant grilled tortilla. The combination of the receptacle and the presser allows the tortilla to retain its shape during grilling and heating, while achieving the desired hardness and crispiness as assisted by effective moisture removal.

The above embodiments of the invention provide a grilling apparatus and a method that facilitate preparation of tortilla wraps. The grilled tortilla can be formed with a desired shape and structure that allows a filling to the placed inside and be ready for serving, reducing time for making a tortilla wrap, for example, by eliminating the step of rolling up after the filling is placed inside the wrap. Further, various vents of the grilling apparatus according to the invention, particularly those on the receptacle and the presser, provide sufficient pathways for moisture to be removed, resulting in a well-cooked and crispy grilled tortilla. Advantageously, by allowing both sides of the tortilla to be grilled simultaneously, the method of making a tortilla wrap described herein results in a tortilla wrap having a controlled thickness and desired dryness and density.

It will be appreciated by persons skilled in the art that numerous variations and/or modifications may be made to the invention as shown in the specific embodiments without departing from the spirit or scope of the invention as broadly described. The described embodiments of the invention should therefore be considered in all respects as illustrative, not restrictive. The grilling apparatus may be used for preparing other food using a tortilla, or for preparing food using other food material sheets that are substantially thin and flat edible materials, for example, cooked doughs such as flatbreads or thinly sliced meat. The grilling apparatus may only include one receptacle with one heating element.

For example, the structure and arrangement of the receptacle and the presser may be different from those illustrated. The receptacle may be removable from the housing for cleaning or even replacing with another receptacle with a different shape or size to obtain a grilled food material sheet with the desired shape or size. The receptacle may have a shape other than an inverted frusto-conical shape, for example, a generally inverted conical shape, a generally inverted pyramidal shape, or a generally inverted rectangular shape. The vent at the lower end may be instead positioned at any position adjacent or above the lower end, through the inner surface of the wall, or be completely omitted (for holding, e.g., ice cream). The receptacle may include a single groove defining a single channel. The channel may extend and along only part of the inner surface of the receptacle, instead of between the upper and lower ends thereof. The illustrated receptacle may be provided as a mesh structure, where the vents and channels are readily provided by the holes through the mesh structure. The presser may have a shape that is not complementary to that of the receptacle, or a shape other than an inverted frusto-conical shape, for example, a generally inverted conical shape, a generally inverted pyramidal shape, or a generally inverted rectangular shape. The presser body may have a cage structure formed by grids. The handle of the presser may be arranged at another position of the body. As such, the longitudinal axis and the central of the body of the presser may not be co-axial.

For example, the structure and arrangement of the heating element may be different from those illustrated. The heating element may be provided at any position adjacent the receptacle, as long as it is close enough to apply heat to the receptacle thus the food material sheet. The heating element may be provided in a form other than a spiral, e.g. a helical around the outer surface of the receptacle, or a number of strips on the outer surface of the receptacle.

For example, the configuration of the electrical components may be different from those illustrated. The grilling apparatus may only include one actuator, one indicator, and one controller for simultaneously controlling operation of all of the heating elements, allowing for a more convenient operation. The actuator may be provided in the form of a button, a touchpad, etc. The actuator may additionally be configured to adjust the temperature of the heating element. The indicator may be configured to blink within a predetermined time period after the heating element has been turned off, to warn the user that the receptacle is still hot. The indicator may be provided in the form of an alarm or a display.

The method of making the rolled-up tortilla may also be different from those illustrated. For example, the steps may be performed in a different order. As an example, the bottom end of the assembly may be folded before the lateral sides are folded, as long as the wall of the resultant rolled-up tortilla has only one opening that is for food to be placed in. The resultant rolled-up tortilla or grilled tortilla may have a shape other than a frusto-conical shape, for example, a generally inverted conical shape, a generally inverted pyramidal shape, or a generally inverted rectangular shape.

1. An item of food, comprising:
a body for retaining food elements, the body having a wall defining a larger open end through which the food elements may be placed in the body and a smaller closed end,
the wall being formed by:
rolling up an assembly of a first layer of food material, a second layer of food material, and a filling food material arranged therebetween, such that the rolled-up assembly assumes a shape; and
heating the rolled-up assembly to retain the shape of the rolled-up assembly.

2. The item of food according to claim 1, wherein the body consists of the wall.

3. The item of food according to claim 1, wherein the body has a generally conical shape.

4. The item of food according to claim 1, wherein the body has a generally frusto-conical shape.

5. The item of food according to claim 1, wherein the smaller closed end is formed by folding a portion of a periphery of the assembly inwards.

6. The item of food according to claim 1, wherein upper peripheries of each of the first layer of food material and the second layer of food material are substantially aligned with each other.

7. The item of food according to claim 1, wherein at least one of the first layer of food material and the second layer of food material is generally circular.

8. The item of food according to claim 7, wherein one of the first layer of food material and the second layer of food material is generally circular, and the other one is fan-shaped.

9. The item of food according to claim 7, wherein the first layer of food material and the second layer of food material have substantially the same shape and size.

10. The item of food according to claim 1, wherein the first layer of food material and the second layer of food material are cooked food materials.

11. The item of food according to claim 10, wherein the first layer of food material and the second layer of food material are cooked doughs.

12. The item of food according to claim 11, wherein the first layer of food material and the second layer of food material are food material sheets.

13. The item of food according to claim 1, wherein the rolled-up assembly is relatively soft and the wall is relatively hard.

14. The item of food according to claim 1, wherein the filling food material occupies substantially the entire space between the first layer of food material and the second layer of food material.

15. The item of food according to claim 1, wherein the filling food material is different from the first layer of food material and the second layer of food material.

16. The item of food according to claim 1, wherein the filling food material is a meltable food material.

17. A grilling apparatus for preparing food using a food material sheet, comprising:
a receptacle for receiving a said food material sheet, the receptacle having:
an upper end through which a said food material sheet may be placed into the receptacle,
a lower end smaller than the upper end, and
a wall having an inner surface extending across the upper end and the lower end and arranged to contact and support a said food material sheet placed inside the receptacle; and
a heating element provided adjacent and behind the inner surface for applying heat through the inner surface to a said food material sheet placed inside the receptacle, thereby grilling a said food material sheet to a shape corresponding to that of the inner surface;
wherein the receptacle includes a vent through the inner surface to allow air to enter into the receptacle from outside during grilling of a said food material sheet.

18. The grilling apparatus according to claim 17, wherein the vent is provided adjacent the lower end of the receptacle.

19. The grilling apparatus according to claim 18, wherein the vent comprises an aperture through the wall of the receptacle.

20. The grilling apparatus according to claim 17, wherein the vent extends on and along at least part of the inner surface of the receptacle.

21. The grilling apparatus according to claim 20, wherein the vent comprises at least one channel extending to between the upper end and the lower end of the receptacle.

22. The grilling apparatus according to claim 21, wherein the vent comprises a plurality of said channels that are regularly spaced apart from each other.

23. The grilling apparatus according to claim 17, wherein the inner surface extends linearly across the upper end and the lower end of the receptacle.

24. The grilling apparatus according to claim 23, wherein the receptacle has a substantially inverted conical shape.

25. The grilling apparatus according to claim 24, wherein the receptacle has an inverted frusto-conical shape.

26. The grilling apparatus according to claim 17, wherein the heating element extends around the receptacle.

27. The grilling apparatus according to claim 26, wherein the heating element is of a spiral shape.

28. The grilling apparatus according to claim 17, including a presser adapted to be insertable into the receptacle for exerting a force to bear a said food material sheet against the inner surface of the receptacle, thereby maintaining contact therebetween.

29. The grilling apparatus according to claim 28, wherein the presser has a body of a shape and size complementary to those of the receptacle.

30. The grilling apparatus according to claim 29, wherein the body has a substantially inverted conical shape.

31. The grilling apparatus according to claim 30, wherein the body has an inverted frusto-conical shape.

32. The grilling apparatus according to claim 29, wherein the presser includes a handle connected to the body, extending along a longitudinal axis of the latter.

33. The grilling apparatus according to claim 32, wherein the body is made of a metal.

34. The grilling apparatus according to claim 32, wherein the handle is made of a non-metal.

35. The grilling apparatus according to claim 29, wherein the body is a hollow structure with an open outer surface.

36. The grilling apparatus according to claim 29, wherein the body comprises a plurality of protrusions extending from a central axis of the body.

37. The grilling apparatus according to claim 36, wherein the plurality of protrusions are in form of fins.

38. The grilling apparatus according to claim 37, wherein each fin is solid.

39. The grilling apparatus according to claim 37, wherein each fin is formed by a wire.

40. The grilling apparatus according to claim 29, wherein the body is in the form of a cage.

41. The grilling apparatus according to claim 29, wherein the body includes a plurality of edges on and around its outer periphery, which extend generally across opposite ends of the body.

42. The grilling apparatus according to claim 41, wherein the edges extend linearly across opposite ends of the body.

43. The grilling apparatus according to claim 17, further including a housing in which the receptacle is provided.

44. The grilling apparatus according to claim 43, including a plurality of said receptacle and respective heating elements, with upper ends thereof arranged on an upper surface of the housing.

45. A method of making an item of food according to claim 1, comprising the steps of:
rolling up the assembly of the first layer of food material, the second layer of food material, and the filling food material arranged therebetween; and
placing the rolled-up assembly into the receptacle of a grilling apparatus according to claim 17, whereby the rolled-up assembly is heated to form the item of food.

46. The method according to claim 45, wherein the step of rolling up the assembly comprises the steps of:
placing the filling food material between the first layer of food material and the second layer of food material to form the assembly;
and then, irrespective of order,
folding a lateral side of the assembly inwards;
folding a portion of a periphery of the assembly between opposite lateral sides inwards; and
folding the opposite lateral side inwards, thereby forming the assembly with the smaller closed end.

47. The method according to claim 45, further including the step of inserting a presser of the grilling apparatus into the receptacle to exert a force to bear the rolled-up assembly against the inner surface of the receptacle, thereby maintaining contact therebetween for grilling.

48. The method according to claim 47, further including the step of pre-heating the presser before inserting the presser into the receptacle.

49. The method according to claim 48, wherein the step of pre-heating the presser includes inserting the presser into the receptacle for pre-heating.

50. The method according to claim 49,
wherein, after the step of inserting the presser into the receptacle and prior to the step of placing the rolled-up assembly into the receptacle, the method further includes the step of removing the pre-heated presser from the receptacle, and
wherein, after the step of placing the rolled-up assembly into the receptacle, the method further includes the step of re-inserting the pre-heated presser into the receptacle to exert a force to bear the rolled-up assembly against the inner surface of the receptacle, thereby maintaining contact of the first and second layers of food material with the inner surface of the receptacle and an outer surface of the presser respectively for grilling.
